(19) United States
(12) Patent Application Publication
(10) Pub. No.: US 2013/0287100 A1
(43) Pub. Date: Oct. 31, 2013

(54) MECHANISM FOR FACILITATING COST-EFFICIENT AND LOW-LATENCY ENCODING OF VIDEO STREAMS

(71) Applicants: WOOSEUNG YANG, Sunnyvale, CA (US); JU HWAN YI, Sunnyvale, CA (US); YOUNG IL KIM, Sunnyvale, CA (US); HOON CHOI, Sunnyvale, CA (US)

(72) Inventors: WOOSEUNG YANG, Sunnyvale, CA (US); JU HWAN YI, Sunnyvale, CA (US); YOUNG IL KIM, Sunnyvale, CA (US); HOON CHOI, Sunnyvale, CA (US)

(21) Appl. No.: 13/460,393

(22) Filed: Apr. 30, 2012

(51) Int. Cl. H04N 7/26

(52) U.S. Cl. 375/240.04; 375/240.06; 375/E07.139

(57) ABSTRACT

A mechanism for facilitating cost-efficient and low-latency video stream encoding for limited channel bandwidth is described. In one embodiment, an apparatus includes a source device having an encoding logic. The encoding logic may include a first logic to receive a video stream having a plurality of video frames. The video stream is received frame-by-frame. The encoding logic may further include a second logic to determine an input data rate relating to a first current video frame of the plurality of video frames received at the encoding mechanism, and a third logic to generate one or more zero-delta frames based on the input data rate, and allocate the one or more zero-delta frames to one or more first video frames of the plurality of video frames subsequent to the first current video frame.

### TECHNICAL FIELD

Embodiments of the invention generally relate to encoding of motion pictures and, more particularly, to a mechanism for facilitating cost-efficient and low-latency encoding of video streams.

### BACKGROUND

Encoding of video streams (e.g., motion pictures) is a well-known technique for removing redundancy from special and temporal domains of the video streams. For example, an I-picture of a video stream is obtained by reducing spatial redundancy of a given picture of the video stream, while a P-picture is produced by removing temporal redundancy residing between a current frame and any previously-encoded (referenced) frames or pictures of the video stream. Conventional systems attempt to reduce spatial and temporal redundancy by investigating multiple reference frames to determine redundant portions of video streams; consequently, these systems require high processing time and added hardware resources while inevitably incurring high latency as well as requiring large amount of memory. The excessive hardware cost makes the conventional systems expensive to employ and while the associated high latency keeps these conventional systems inefficient and unsuitable for certain latency-sensitive applications, such as video conferencing applications and games, etc.

FIG. 1 illustrates a prior art video stream encoding technique. As aforementioned, conventionally, previously-encoded frames of a video stream are used as reference frames for inter-prediction of encoding the next or incoming frames. For example, as illustrated, FIG. 1 illustrates an exemplary input video stream 102 having 20 frames. Using the conventional encoding technique, an I-picture 114 is first produced, followed by a set of fixed or variable number of P-pictures 118 including frames 2 thru 10. An initial set of P-pictures 118 is followed by another I-picture 116. Subsequent to I-picture 116, multiple reference frames are then used for generating another set of P-pictures 120 (including frames 12 thru 20) to maximize the compression ratio. Moreover, using this conventional rate control system, shown here in prior art FIG. 1, the rate control is performed over a large number of frames to be able to gather information on how much data is accumulated for a leading I-frame 114, 116 and the corresponding set of P-frames 118, 120 that follows it, which, naturally, results in a slow response to the channel status.

### SUMMARY

A mechanism for facilitating cost-efficient and low-latency video stream encoding for limited channel bandwidth is described.

In one embodiment, an apparatus includes a source device having an encoding logic. The encoding logic includes a first logic to receive a video stream having a plurality of video frames. The video stream is received frame-by-frame. The encoding logic may further include a second logic to determine an input data rate relating to a first current video frame of the plurality of video frames received at the encoding mechanism, and a third logic to generate one or more zero-delta frames based on the input data rate, and allocate the one or more zero-delta frames to one or more first video frames of the plurality of video frames subsequent to the first current video frame.

In one embodiment, a system includes a source device having a processor coupled to a memory device and further having an encoding mechanism. The encoding mechanism to receive a video stream having a plurality of video frames. The video stream is received frame-by-frame. The encoding mechanism may be further to determine an input data rate relating to a first current video frame of the plurality of video frames received at the encoding mechanism, and generate one or more zero-delta frames based on the input data rate, and allocate the one or more zero-delta frames to one or more first video frames of the plurality of video frames subsequent to the first current video frame.

In one embodiment, a method may include receiving a video stream having a plurality of video frames. The video stream is received frame-by-frame. The method may further include determining an input data rate relating to a first current video frame of the plurality of video frames received at the encoding mechanism, and generating one or more zero-delta frames based on the input data rate, and allocate the one or more zero-delta frames to one or more first video frames of the plurality of video frames subsequent to the first current video frame.

### BRIEF DESCRIPTION OF THE DRAWINGS

Embodiments of the invention are illustrated by way of example, and not by way of limitation, in the figures of the accompanying drawings in which like reference numerals refer to similar elements:

FIG. 1 illustrates a prior art video stream encoding technique;

FIG. 2 illustrates a source device employing a cost-efficient, low-latency dynamic encoding mechanism according to one embodiment;

FIG. 3 illustrates a dynamic encoding mechanism according to one embodiment;

FIGS. 4A, 4B and 4C illustrate zero-delta-prediction frame-based dynamic encoding of a video stream according to one embodiment;

FIGS. 5A, 5B and 5C illustrate a process for zero-delta-prediction-macro-block-based dynamic encoding of a video stream according to one embodiment; and

FIG. 6 illustrates a computing system according to one embodiment of the invention.

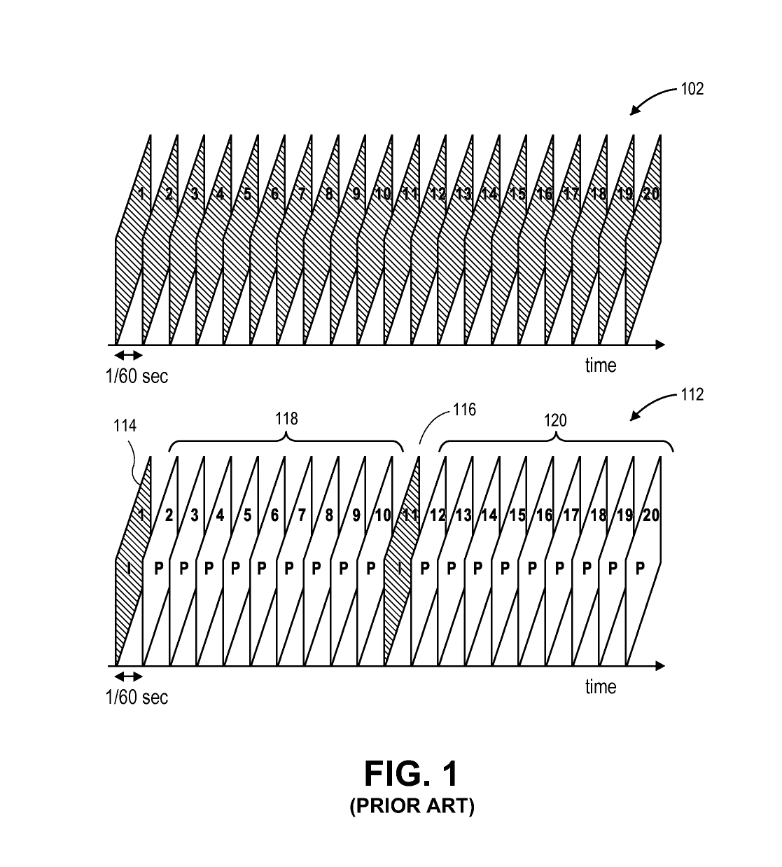

### DETAILED DESCRIPTION

Embodiments of the invention are directed to facilitating cost-efficient and low-latency video stream encoding for limited channel bandwidth. In one embodiment, this novel scheme applies rate control frame-by-frame such that if a single frame consumes too much bandwidth, the quality of the next (following) frame(s) may be controlled by raising a quantization parameter (QP) value and, at the same time, one or more frames may be skipped by having one or more zero-delta prediction (ZDP) frames (ZDPFs) or zero-delta prediction macro-blocks (ZDP-MB). This novel technique, for example, is distinct from and advantageous over a conventional rate control system where the rate control is performed over a large number of frames to be able to gather information on how much data is accumulated for a leading I-frame and the corresponding set of P-frames that follows it, which, naturally, results in a slow response to the channel status.

A P-frame or predicted frame may refer to a frame constructed from a previous frame (e.g., through prediction) with some modification (e.g., delta). To calculate the delta portion, an encoder may need a large memory to store one or more full frames. A ZDPF refers to a P-frame having zero-delta. Since its delta portion is zero, a ZDPF may be the same as the predicted frame and without any frame memory requirement. A ZDP-MB includes a ZDP-MB which may include 4×4 or 16×16 pixel blocks of a frame. Generally, an I-frame is composed of all I-MBs, while a P-frame may be composed of an I-MB and a P-MB. A P-MB refers to a macro-block that is composed of prediction and delta, while a ZDP-MB refers to a P-MB with zero delta. Although certain advantages of using a ZDP-MB may be the same as using a ZDP-frame; nevertheless, using ZDP-MBs may provide a better fine-grained MB-wise control on choosing an I-frame or a ZDPF. For example and in one embodiment, decision logic along with hash memory of a data rate measurement module may be used to decide whether to send an I-MB or a ZDP-MB.

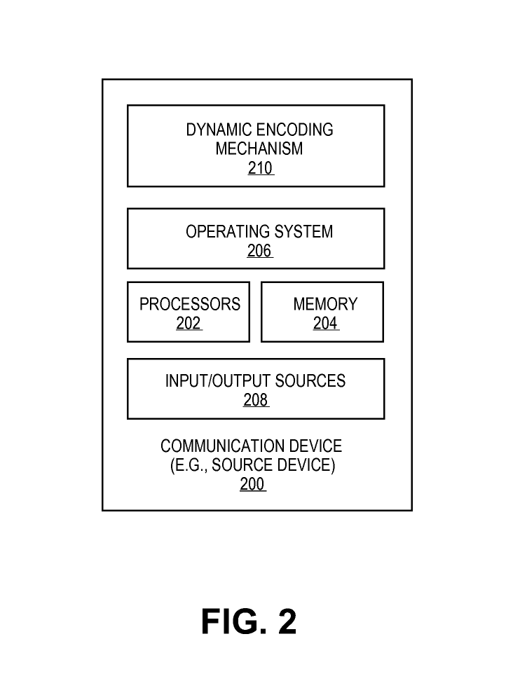

FIG. 2 illustrates a communication device employing a cost-efficient, low-latency dynamic encoding mechanism according to one embodiment. Communication device 200 includes a source device (also referred to as a transmitter or a transmitting device) that is responsible for transmitting data (e.g., audio and/or video streams) to a sink device (also referred to as a receiver or receiving device) over a communication network. Communication device 200 may include any number of components and/or modules that may be common to a sink device or any other such device; however, for brevity, clarity and ease of understanding, the communication device 200 is referred to as a source device throughout this document and particularly with reference to FIG. 2. Examples of a source device 200 may include a computing device, a data terminal, a machine (e.g., a facsimile machine, a telephone, etc.), a video camera, a broadcasting station (e.g., a television or radio station), a cable broadcasting head-end, a set-top box, a satellite, etc. Further examples of a source device 200 may also include consumer electronic devices, such as a personal computer (PC), a mobile computing device (e.g., a tablet computer, a smartphone, etc.), an MP3 player, an audio equipment, a television, a radio, a Global Positioning System (GPS) or navigation device, a digital camera, an audio/video recorder, a Blu-Ray player, a Digital Versatile Disk (DVD) player, a Compact Disk (CD) player, a Video Cassette Recorder (VCR), a camcorder, etc. A sink device (not shown) may include one or more of the same examples as those of the source device 200.

In one embodiment, source device 200 employs a dynamic encoding mechanism (encoding mechanism) 210 for dynamic cost-efficient and low-latency frame-by-frame encoding of video streams (e.g., motion pictures). Source device 200 may include an operating system 206 serving as an interface between any hardware or physical resources of the source device 200 and a sink device or a user. Source device 200 may further include one or more processors 202, memory devices 204, network devices, drivers, or the like, as well as input/output (I/O) sources 208, such as a touchscreen, a touch panel, a touch pad, a virtual or regular keyboard, a virtual or regular mouse, etc. Terms like “frame” and “picture” may be used interchangeably throughout this document.

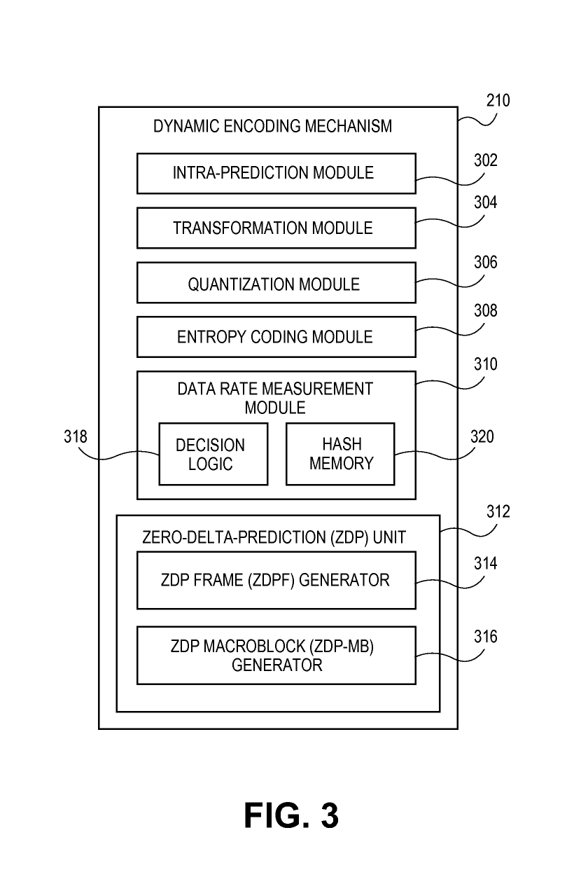

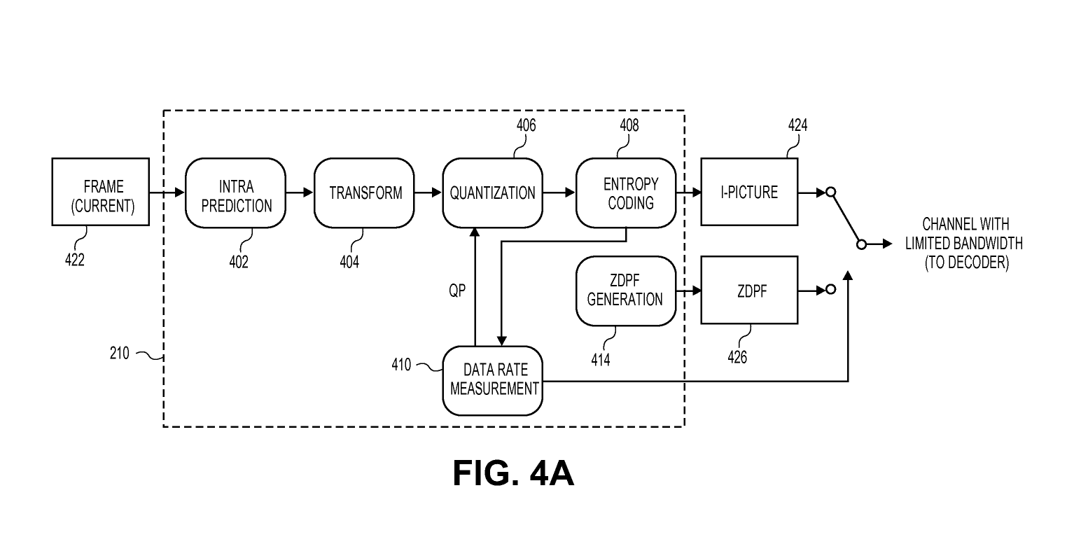

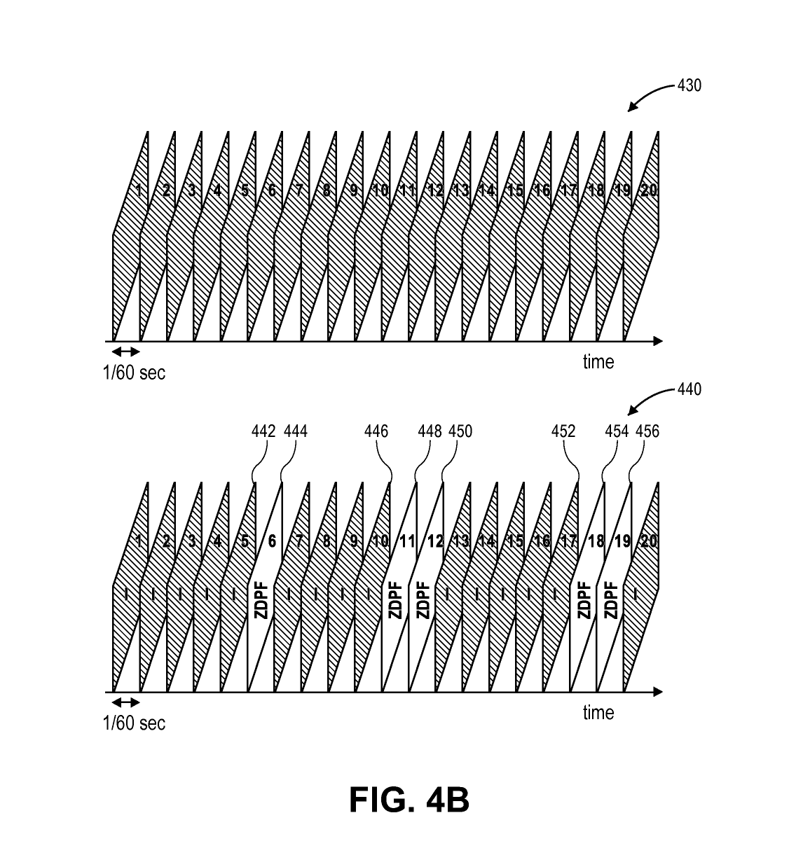

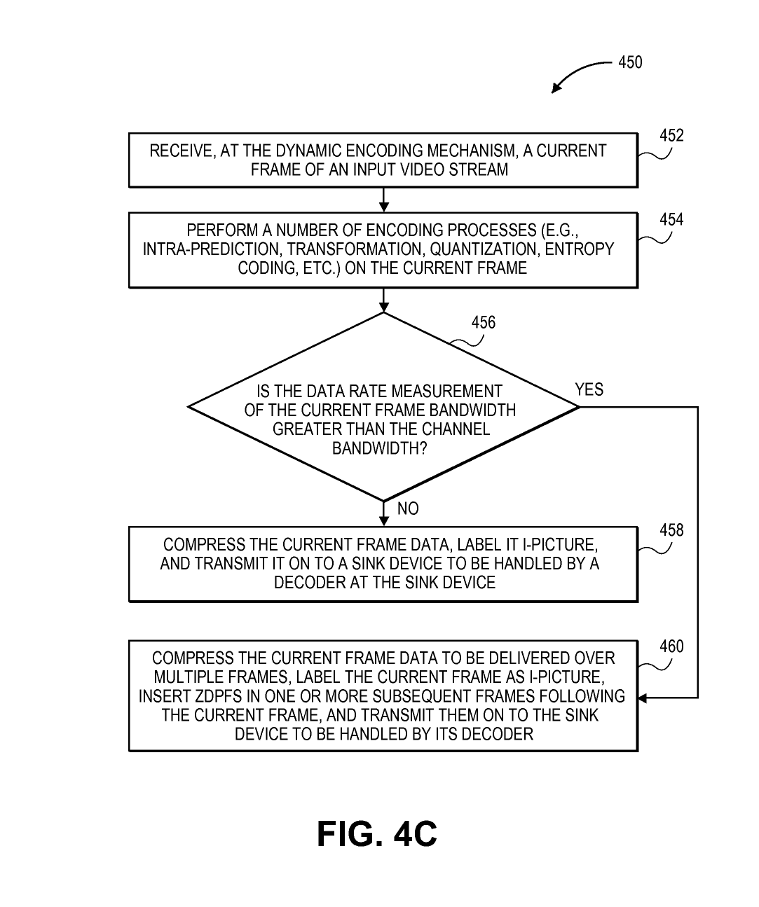

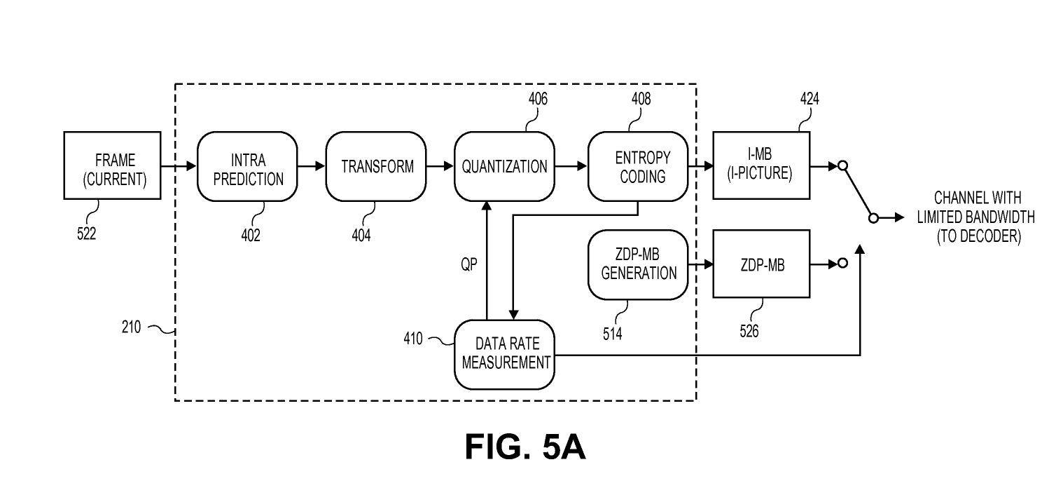

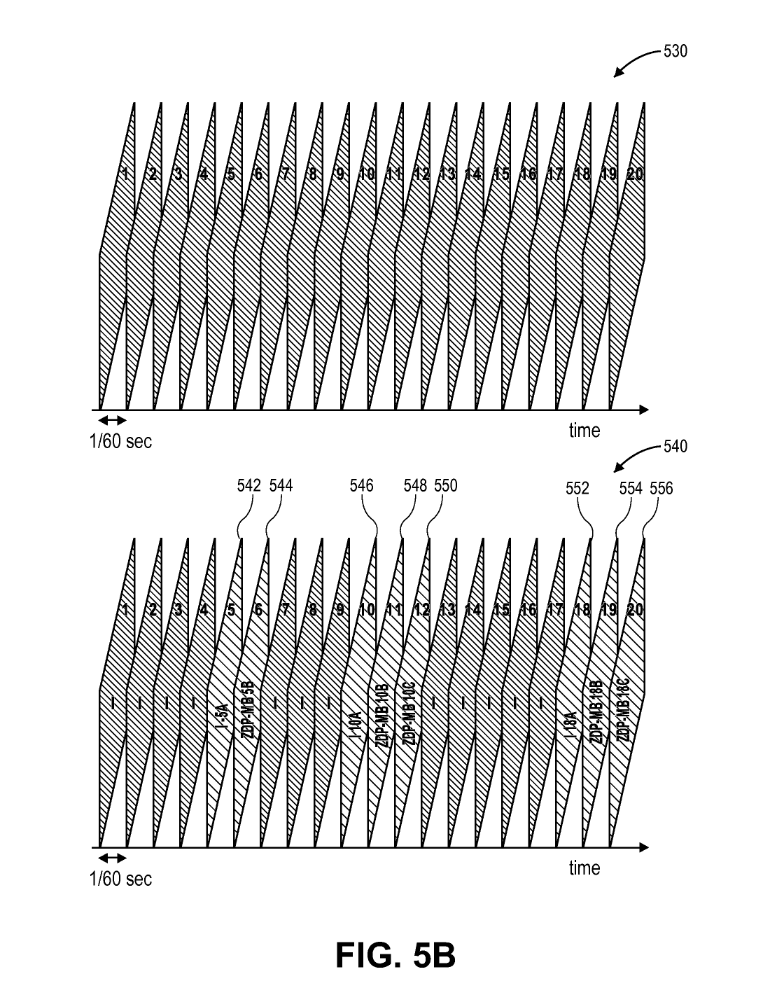

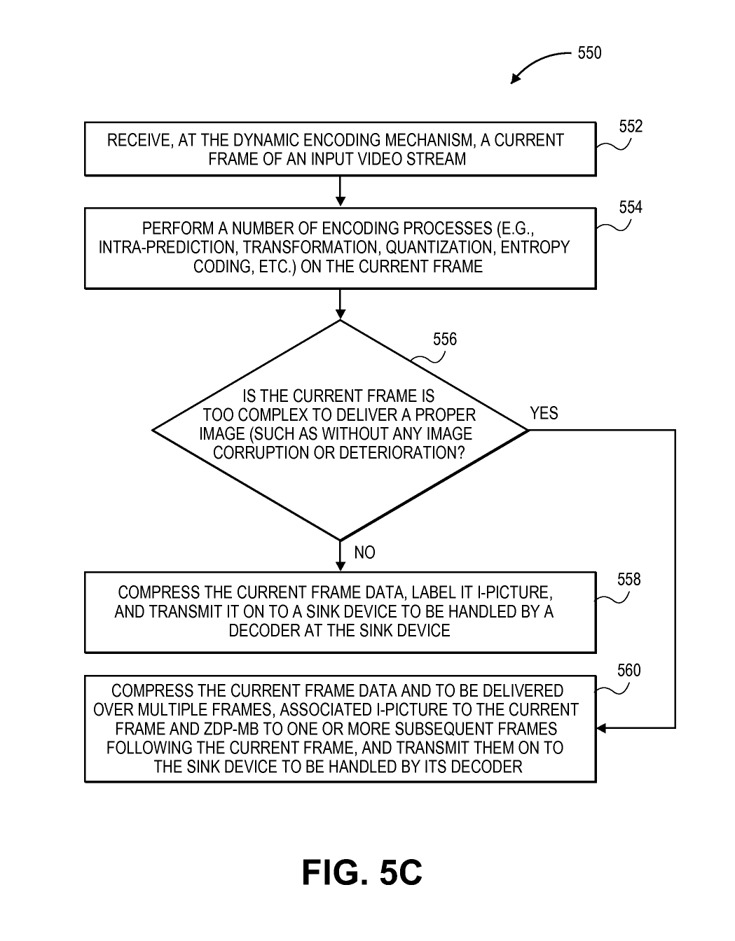

FIG. 3 illustrates a dynamic encoding mechanism according to one embodiment. In the illustrated embodiment, the encoding mechanism 210 includes an intra-prediction module 302, a transformation module 304, a quantization module 306, an entropy coding module 308, a data rate measurement module 310, and a zero-delta-prediction unit 312 having a ZDPF generator 314 and a ZDP-MB generator 316. In one embodiment, the data rate measurement module 310 includes decision logic 318 along with hash memory 320. ZDPFs and ZDP-MBs are examples of delta frames that are used in delta encoding or video compression method for video frames in video data streams. As will be further described with reference to FIGS. 4A, 4B, 4C, 5A, 5B and 5C, the various components 302-312 of the encoding mechanism 210 are used to encode video streams (e.g., motion pictures) such that the encoding is low in cost as well as in latency. In one embodiment, this cost-efficient, low-latency encoding is performed by having the ZDP unit 312 generate ZDPFs and/or ZDP-MBs (e.g., a ZDP-MB may equal a frame having a full or partial I-picture and a full or partial ZDPF, such as I-picture/ZDPF) and placing them within any number of frames of an input video stream.

FIGS. 4A, 4B and 4C illustrate ZDPF-based dynamic encoding of a video stream according to one embodiment. FIG. 4A illustrates a current frame 422 of a video stream (e.g., a motion picture video stream) to be encoded is received at the encoding mechanism 210 at a source device. In one embodiment, the current frame 422, like other frames of the video stream, goes through various encoding processes 402-414 to be transmitted to a decoder at a sink device either as an I-picture 424 or a ZDPF 426. The sink device may be coupled to the source device over a communication network. For example and as illustrated, the current frame 422 goes through a process of intra-prediction 402 being performed by the intra-prediction module 302 of FIG. 3. The intra-prediction process 402 is performed to reduce any spatial redundancy within the current frame 422 by searching for the best prediction relating to the current frame 422 so as to whether an I-picture 424 can be generated. Any prediction data provided by the intra-prediction process 402 when deducted from the original data may result in a residue which is then handle through a transformation process 404 performed by the transformation module 304 of FIG. 3. The transformation process 404 primarily relates to changing of domains, such as changing frequency domains, of the current frame 422 based on predictions made by the intra-prediction process 402. For example, any difference or residue determined between a predicted picture and the current frame 422 may go through an image compression process that includes performing a number of processes, such as transformation 404, quantization 406, and entropy coding 408, etc., before a data rate measurement 410 of the current frame 422 can be performed. In one embodiment, the processes of quantization 406, entropy encoding 408 and data rate measurement 410 are performed by the modules of quantization 306, entropy coding 308 and data rate measurement 310, respectively, of the dynamic encoding mechanism 210 of FIGS. 2 and 3.

In one embodiment, a data rate of the current frame 422 is calculated using the data rate measurement process 410. For example and in one embodiment, the data rate measurement process 410 may be used to performed several tasks and the results of which may be used to check to determine the amount of bandwidth required to send or pass the current frame 422 to the sink device. It is contemplated that the data rate measurement process 410 may control the QP value to meet the required channel bandwidth by sacrificing the quality of the image associated with the current frame 422; however, the required bandwidth for the current frame 422 may not be achieved even with a significantly lowered quality of the image (such as even when reaching virtually the minimum image quality). In one embodiment, to overcome this problem, ZDPFs 426 may be generated and inserted into one or more frames that are subsequent to or following the current frame 422 to carry the additional bandwidth required by the current frame 422. The number of ZDPFs 426 or the number of subsequent frames representing the ZDPFs 426 may be based on the amount of extra bandwidth, as compared to the available channel bandwidth, demanded by the current frame 422. The data rate measurement process 410 may be used to calculate the QP value that is then applied to the next input video frame. Further, using the data rate measurement process 410, the decision to use ZDPFs may also be made. However, the two processes of calculating the QP value and the decision to use a ZDPF are regarded as two separate and independent tasks performed in the data rate measurement process 410. For example and in one embodiment, the decision to use a ZDPF is made from the input data rate (not the QP value) obtained from the data rate measurement process 410.

In one embodiment, ZDPF generation 414 is performed using the ZDPF generator 314 of FIG. 3 to generate ZDPFs 426 that are then provided by any number of frames following the current frame 422 to help secure enough bandwidth for transferring the compressed or encoded data (e.g., images) associated with the current frame 422 over to the sink device having a decoder to decompress or decode the received data. In embodiment, one or more ZDPFs 426 are provided by one or more corresponding frames between the current frame 422 represented as a preceding I-picture and a subsequent I-picture associated with a corresponding frame of the video stream to lower the latency. The higher the QP value is determined to be, and as used by the data rate measurement process 410, the more the current frame data compression is needed and vice versa. If, for example, the current frame 422 requires bandwidth that is the same as or less than the normal channel bandwidth typically needed to pass on a frame to the sink device, the current frame data is compressed/encoded and labeled as I-picture 424 by the entropy coding process 408 (using the entropy coding module 308 of FIG. 3), without having to have any ZDPFs in the video stream, and is passed on to be decompressed/decoded at the sink device.

Referring now to FIG. 4B, it illustrates an input video stream 430 and an encoded video stream 440 resulting from using the various processes of the dynamic encoding mechanism 210 of FIG. 4A. In one embodiment and as illustrated, video stream encoding is performed to insert ZDPFs 444, 448-450, 454-456 when the required bandwidth data rate for transferring various I-frames is higher than the channel bandwidth. Although simply producing I-frames may also help reduce spatial redundancy within a motion picture, the compression of this sort, however, does not work well with transmitting frames having complex images to or through a limited bandwidth channel. If the required bandwidth for a current frame is determined to be more than the normal channel bandwidth of one frame time, the current frame data, such as frames 442, 446 and 452, may be transmitted over multiple frame times using one or more ZDPFs 444, 448-450 and 454-456 to occupy one or more subsequent frames in the encoded video stream 440 to make up for the delayed frames. A ZDPF 444, 448-450, 454-456 may represent a type of a P-picture containing contents no different than that of P-pictures and therefore, needing or requiring very small amounts of bandwidth to be transferred and leaving the rest for properly delivering the data contained within the current frames 442, 446 and 452 needing extra bandwidth.

In one embodiment, when a ZDPF 444, 448-450, 454-456 is received by a decoder at the sink device, the decoder may simply repeat the previously decoded picture or frame 442, 446 and 452 that shows the same effect but with a dynamic frame rate control. For example, when ZDPF 444 (representing frame 6 of the encoded video stream 440) is received at the decoder, the decoder simply repeats the previous frame 5 442 until it reaches the subsequent frame 7 and similarly, when frame 10 446 may be repeated from ZDPF-based frames 448-450 until their subsequent frame 13 is reached and so forth. To explain it further, let us suppose, frame 5 442 (or the fifth input frame) is a complex frame that needs 1.5 times the bandwidth of a single frame time. To tackle this situation, in one embodiment, the encoding mechanism 210 generates and sends compressed data for frame 5 442 in the fifth frame time equaling 1.0 times of the 1.5 times the required bandwidth and further inserting a ZDPF in frame 6 444 and sending it in the sixth frame time to represent the rest of the bandwidth equaling 0.5 times of the 1.5 times the bandwidth of a single frame time. Stated differently, in the fifth frame time, the encoding mechanism 210 sends the data of frame 5 442, while in the sixth frame time, the encoding mechanism 210 puts the remaining data of frame 5 442 and a ZDPF in frame 6 444 to be received at the decoder at the sink device.

Similarly, let us suppose if frame 10 446 is even more complex that frame 5 442 and requires 2.5 times the bandwidth of a single frame time. In this case, the encoding mechanism 210 sends the compressed data of frame 10 446 over the tenth frame time as well as the eleventh frame time and the twelfth frame time using frame 11 448, frame 12 450, respectively. The ZDPF generation process 414 of FIG. 4A inserts a ZDPF in each of frames 11 448 and 12 450 to represent images in the remainder or remaining part of the twelfth frame time. In other words, ZDPFs are used to catch up the delayed frame due to previous overflowing of data. The illustrated frames 17 452, 18 454 and 19 456 are similar to frames 10 446, 11 448 and 12 450 and therefore, for brevity, not discussed here. It is contemplated that a frame is not limited to the amount of bandwidth illustrated here and that any amount of bandwidth may be required by a single frame and represented by a number of following frames having ZDPFs and portions of the bandwidth over the channel bandwidth required by a single frame time.

FIG. 4C illustrates a process for a ZDPF-based dynamic encoding of a video stream according to one embodiment. Method 450 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 450 is performed by the dynamic encoding mechanism 210 of FIGS. 2.

Method 450 begins at block 452 with a current frame of an input video stream being received at the dynamic encoding mechanism employed at a source device coupled to a sink device over a communication network. At block 454, a number of encoding processes (e.g., intra-prediction, transformation, quantization, entropy coding, etc.), as described with reference to FIG. 4A, are performed on the current frame. At block 456, a QP value is calculated through the entropy coding and quantization processes using the data rate measurement process 410 of FIG. 4A. The calculated QP value is then applied to the next input video frame. Further, using the data rate measurement process 410, the decision to use ZDPFs is made. However, the two processes of calculating the QP value and the decision to use a ZDPF are regarded as two separate and independent tasks performed in the data rate measurement process 410. For example and in one embodiment, the decision to use a ZDPF is made from the input data rate (not the QP value) obtained from the data rate measurement process 410. The single frame time refers to the amount of available channel bandwidth needed for compression and transmission of data associated with a single frame so that the data can be properly received (e.g., without any image deception or deterioration) at the sink device where it can be decoded by a decoder and displayed by a display device.

At block 458, if the bandwidth is less than or equal to the channel bandwidth of the single frame time, the current frame data is compressed and the current frame is labeled as I-picture and transmitted on to the sink device to be handled by its decoder. At block 460, if the bandwidth is determined to be greater than the channel bandwidth of a single frame time, the current frame data is compressed to be delivered over multiple frames. In other words and in one embodiment, the current frame is labeled as I-picture, while one or more frames following the current frame are assigned ZDPFs to carry the burden of the remaining compressed data and/or provide the additional bandwidth necessitated by the current frame. The current frame (as I-picture) and the one or more subsequent frames (as ZDPFs) are transmitted over to the sink device to decoded and displayed. As described earlier, the number of frames to be referenced as ZDPFs may depend on the complexity of the current frame, such as the amount bandwidth in addition to or over the normal channel bandwidth needed to compress the current frame data and transmit the current frame to the sink device.

FIGS. 5A, 5B and 5C illustrate a process for ZDP-MB-based dynamic encoding of a video stream according to one embodiment. For brevity and ease of understanding, various processes and components mentioned earlier with respect to FIGS. 4A, 4B and 4C are not repeated here. In one embodiment, as illustrated in FIG. 5A, for the most part, a current frame 522 goes through a similar process as that of the current frame 422 of FIG. 4A, except here, data of the current frame 522 is compressed and processed such that a gradual image improvement is introduced to the video stream passing on to a decoder at a sink device in communication with a source device employing the encoding mechanism 210. For example, a current frame 522 may be too complex to be rendered properly, such as it can only be rendered with distorted or unnatural image.

In embodiment, as described with reference to FIGS. 4A, 4B and 4C, any number of ZDPFs may be introduced to a video stream to lower or eliminate the complexity of the current frame 522. In another embodiment, as illustrated here, any number of ZDP-MBs 526 are associated with a corresponding number of frames of a video stream to eliminate any complexity associated with a current frame and allow the viewer to view images associated with the video stream without any unnatural movement of objects of the images. The use of ZDP-MBs 526 in various frames of a video stream reduces or even removes any complexity by introducing gradual updating of the images of the video stream.

Further, a data rate measurement process 410 may be used to calculate a QP value that is then applied to the next input video frame. Further, using the data rate measurement process 410, the decision to use ZDP-MBs 526 may also be made. However, the two processes of calculating the QP value and the decision to use a ZDP-MB 526 are regarded as two separate and independent tasks performed in the data rate measurement process 410. For example and in one embodiment, the decision to use a ZDP-MB 526 is made from the input data rate (not the QP value) obtained from the data rate measurement process 410. The higher the QP value is determined to be, and as used by the data rate measurement process 410, the more the current frame data compression is needed and vice versa. Generally, an I-frame is composed of all I-MBs 424, while a P-frame may be composed of an I-MB 424 and a P-MB. A P-MB refers to a macro-block that is composed of prediction and delta, while a ZDP-MB 526 refers to a P-MB with zero delta. Although certain advantages of using a ZDP-MB 526 may be the same as using a ZDPF of FIG. 4A; nevertheless, using ZDP-MBs 526 may provide a better fine-grained MB-wise control on choosing an I-frame or a ZDPF. For example and in one embodiment, the data rate measurement process 410 uses decision logic 318 along with hash memory 320 of the data rate measurement module 310 of FIG. 3 to decide whether to send or employ an I-MB 424 or a ZDP-MB 526 in one or more frames of the data stream.

Stated differently, instead of sending a ZDPF in a frame having no different information than contained in a preceding frame, as described with reference to the previous embodiment, in this embodiment, various I-blocks are distributed over multiple P-pictures. For example, as illustrated in FIG. 5B, if frame 10 546 (received through an input video stream 530) is determined to be a complex frame, the I-blocks for the this tenth frame 546 may be delivered over three picture time frames, such as frame 10 546, frame 11 548 and frame 12 550 are assigned an I-block 424 by the entropy coding process 408 and further assigned a ZDP-MB 526 by the ZDP-MB generation process 514 of the encoding mechanism 210 of FIG. 5A. Continuing with the example, frame 10 546 represents an I-block (also referred to as “I-picture” or “I-MB” or simply “I”), while the ZDP-MBs of frames 11 548 and 12 550 may represent the I-MB/ZDP-MB combination. In other words, the first of the three frames, such as frame 10 546, having I-block may be regarded as an I-picture or an I-MB that first delivers a reasonable image quality that meets latency and bandwidth requirements, which is then followed by the last two of the three frames, such as frames 11 548 and 12 550, having ZDP-MBs can be regarded as P-pictures having regional I-blocks to help improve the image quality over multiple frames. This way, the image quality that is to be delivered by frame 10 546 is gradually improved over multiple subsequent frames 11 548 and 12 550. Similar technique is applied to other complex frames 5 542 and 18 552 using their subsequent frames 6 544 and frames 19 554 and 20 556, respectively. This novel technique may be extremely useful for delivering certain stationary images, such as those relating to computer presentation-related applications (e.g., Microsoft® PowerPoint®, Apple® Keynote®, etc.).

FIG. 5C illustrates a process for a ZDP-MB-based dynamic encoding of a video stream according to one embodiment. Method 550 may be performed by processing logic that may comprise hardware (e.g., circuitry, dedicated logic, programmable logic, microcode, etc.), software (such as instructions run on a processing device), or a combination thereof, such as firmware or functional circuitry within hardware devices. In one embodiment, method 550 is performed by the dynamic encoding mechanism 210 of FIGS. 2.

Method 550 begins at block 552 with a current frame of an input video stream being received at the dynamic encoding mechanism employed at a source device coupled to a sink device over a communication network. At block 554, a number of encoding processes (e.g., intra-prediction, transformation, quantization, entropy coding, etc.), as described with reference to FIG. 5A, are performed on the current frame. At block 556, using a QP value that is calculated through the entropy coding and quantization processes, a determination is made as to whether the data rate measurement has found the current frame to be too complex to deliver a proper image (such as without any image corruption or deterioration) to a viewer via a display device at a sink device. For example, various frames of a video stream may require much greater bandwidth than the normal channel bandwidth which could lead to corrupt (e.g., slow moving) rendering of images associated with such frames.

At block 558, if the current frame is not too complex and/or its required bandwidth is less than or equal to the channel bandwidth of the single frame time, the current frame data is compressed and the current frame is labeled as I-picture and transmitted on to the sink device to be handled by its decoder. At block 560, if the current frame is determined to be too complex and/or if the bandwidth is determined to be greater than the channel bandwidth of a single frame time, the current frame data is compressed to be delivered over multiple frames. In other words and in one embodiment, the current frame data is compressed and to be delivered over multiple frames. The current frame is labeled I-picture, while one or more ZDP-MBs are associated with one or more subsequent frames following the current frame. The current frame and the subsequent ZDP-MB-based frames are transmitted on to the sink device to be decoded at a decoder employed by the sink device and subsequently, displayed as images on a display device.

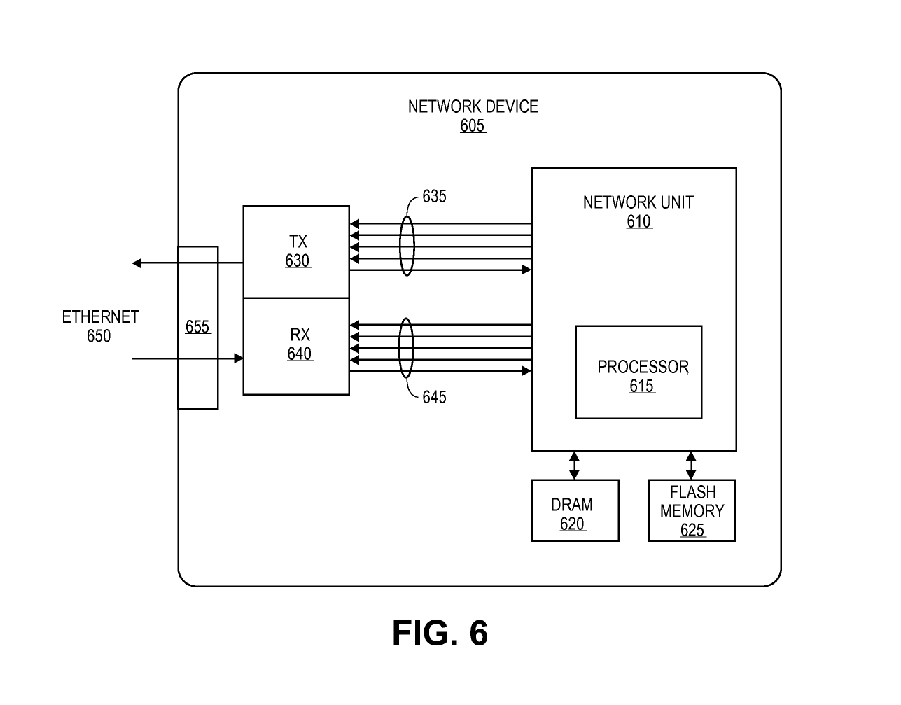

FIG. 6 illustrates components of a network computer device 605 employing an embodiment of the present invention. In this illustration, a network device 605 may be any device in a network, including, but not limited to, a computing device, a network computing system, a television, a cable set-top box, a radio, a Blu-ray player, a DVD player, a CD player, an amplifier, an audio/video receiver, a smartphone, a Personal Digital Assistant (PGA), a storage unit, a game console, or other media device. In some embodiments, the network device 605 includes a network unit 610 to provide network functions. The network functions include, but are not limited to, the generation, transfer, storage, and reception of media content streams. The network unit 610 may be implemented as a single system on a chip (SoC) or as multiple components.

In some embodiments, the network unit 610 includes a processor for the processing of data. The processing of data may include the generation of media data streams, the manipulation of media data streams in transfer or storage, and the decrypting and decoding of media data streams for usage. The network device may also include memory to support network operations, such as Dynamic Random Access Memory (DRAM) 620 or other similar memory and flash memory 625 or other nonvolatile memory. Network device 605 also may include a read only memory (ROM) and or other static storage device for storing static information and instructions used by processor 615.

A data storage device, such as a magnetic disk or optical disc and its corresponding drive, may also be coupled to network device 605 for storing information and instructions. Network device 605 may also be coupled to an input/output (I/O) bus via an I/O interface. A plurality of I/O devices may be coupled to I/O bus, including a display device, an input device (e.g., an alphanumeric input device and or a cursor control device). Network device 605 may include or be coupled to a communication device for accessing other computers (servers or clients) via external data network. The communication device may comprise a modem, a network interface card, or other well-known interface device, such as those used for coupling to Ethernet, token ring, or other types of networks.

Network device 605 may also include a transmitter 630 and/or a receiver 640 for transmission of data on the network or the reception of data from the network, respectively, via one or more network interfaces 655. Network Device 605 may be the same as the communication device 200 employing the cost-efficient, low-latency dynamic encoding mechanism 210 of FIG. 2. The transmitter 630 or receiver 640 may be connected to a wired transmission cable, including, for example, an Ethernet cable 650, a coaxial cable, or to a wireless unit. The transmitter 630 or receiver 640 may be coupled with one or more lines, such as lines 635 for data transmission and lines 645 for data reception, to the network unit 610 for data transfer and control signals. Additional connections may also be present. The network device 605 also may include numerous components for media operation of the device, which are not illustrated here.

Network device 605 may be interconnected in a client/server network system or a communication media network (such as satellite or cable broadcasting). A network may include a communication network, a telecommunication network, a Local Area Network (LAN), Wide Area Network (WAN), Metropolitan Area Network (MAN), a Personal Area Network (PAN), an intranet, the Internet, etc. It is contemplated that there may be any number of devices connected via the network. A device may transfer data streams, such as streaming media data, to other devices in the network system via a number of standard and non-standard protocols.

In the description above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form. There may be intermediate structure between illustrated components. The components described or illustrated herein may have additional inputs or outputs which are not illustrated or described.

Various embodiments of the present invention may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

One or more modules, components, or elements described throughout this document, such as the ones shown within or associated with an embodiment of a DRAM enhancement mechanism may include hardware, software, and/or a combination thereof. In a case where a module includes software, the software data, instructions, and/or configuration may be provided via an article of manufacture by a machine/electronic device/hardware. An article of manufacture may include a machine accessible/readable medium having content to provide instructions, data, etc.

Portions of various embodiments of the present invention may be provided as a computer program product, which may include a computer-readable medium having stored thereon computer program instructions, which may be used to program a computer (or other electronic devices) to perform a process according to the embodiments of the present invention. The machine-readable medium may include, but is not limited to, floppy diskettes, optical disks, compact disk read-only memory (CD-ROM), and magneto-optical disks, read-only memory (ROM), random access memory (RAM), erasable programmable read-only memory (EPROM), EEPROM, magnet or optical cards, flash memory, or other type of media/machine-readable medium suitable for storing electronic instructions. Moreover, the present invention may also be downloaded as a computer program product, wherein the program may be transferred from a remote computer to a requesting computer.

Many of the methods are described in their most basic form, but processes can be added to or deleted from any of the methods and information can be added or subtracted from any of the described messages without departing from the basic scope of the present invention. It will be apparent to those skilled in the art that many further modifications and adaptations can be made. The particular embodiments are not provided to limit the invention but to illustrate it. The scope of the embodiments of the present invention is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. An apparatus comprising:
a source device having an encoding logic, the encoding logic having
a first logic to receive a video stream having a plurality of video frames, wherein the video stream is received frame-by-frame;
a second logic to determine an input data rate relating to a first current video frame of the plurality of video frames received at the encoding mechanism; and
a third logic to generate one or more zero-delta frames based on the input data rate, and allocate the one or more zero-delta frames to one or more first video frames of the plurality of video frames subsequent to the first current video frame.

2. The apparatus of claim 1, wherein the third logic is further to calculate a quantization parameter (QP) value, and apply the calculated quantization parameter value to a next input video frame.

3. The apparatus of claim 1, wherein the encoding logic further includes a fourth logic to transmit the video stream to a sink device coupled to the source device while managing frame-by-frame transmission of the video stream when the first current video frame consumes an amount of bandwidth that is determined to be greater than a normal amount of bandwidth required to communicate a single frame of the video stream.

4. The apparatus of claim 3, wherein managing the frame-by-frame transmission is performed by raising the QP value of the next input video frame and, simultaneously, skipping the one or more first video frames that are allocated the one or more zero-delta frames.

5. The apparatus of claim 1, wherein the third logic is further to generate one or more zero-delta frame macro-blocks based on the input data rate, and allocate the one or more zero-delta frame macro-blocks to one or more second video frames of the plurality of video frames subsequent to a second current frame, wherein the second current frame has a level of complexity that is determined to be greater than a normal level of complexity required to deliver and display the video stream at a normal quality.

6. The apparatus of claim 5, wherein the fourth logic is further to transmit the video stream to the sink device coupled to the source device while maintaining frame-by-frame quality of the video stream, wherein maintaining the frame-by-frame quality is performed by raising the QP value of the next input video frame and, simultaneously, skipping the one or more second video frames that are allocated the one or more zero-delta frame macro-blocks.

7. The apparatus of claim 5, wherein the normal level of complexity is required for the second current video frame to pass to and be displayed at the sink device without deteriorating an image associated with the second current video frame.

8. A system comprising:
a source device having a processor coupled to a memory device and further having an encoding mechanism, wherein the encoding mechanism is further to
receive a video stream having a plurality of video frames, wherein the video stream is received frame-by-frame;
determine an input data rate relating to a first current video frame of the plurality of video frames received at the encoding mechanism; and
generate one or more zero-delta frames based on the input data rate, and allocate the one or more zero-delta frames to one or more first video frames of the plurality of video frames subsequent to the first current video frame.

9. The system of claim 8, wherein the encoding mechanism is further to calculate a quantization parameter (QP) value, and apply the calculated quantization parameter value to a next input video frame.

10. The system of claim 8, wherein the encoding mechanism is further to transmit the video stream to a sink device coupled to the source device while managing frame-by-frame transmission of the video stream when the first current video frame consumes an amount of bandwidth that is determined to be greater than a normal amount of bandwidth required to communicate a single frame of the video stream.

11. The system of claim 10, wherein managing the frame-by-frame transmission is performed by raising the QP value of the next input video frame and, simultaneously, skipping the one or more first video frames that are allocated the one or more zero-delta frames.

12. The system of claim 8, wherein the encoding mechanism is further to generate one or more zero-delta frame macro-blocks based on the input data rate, and allocate the one or more zero-delta frame macro-blocks to one or more second video frames of the plurality of video frames subsequent to a second current frame, wherein the second current frame has a level of complexity that is determined to be greater than a normal level of complexity required to deliver and display the video stream at a normal quality.

13. The system of claim 12, wherein the encoding mechanism is further to transmit the video stream to the sink device coupled to the source device while maintaining frame-by-frame quality of the video stream, wherein maintaining the frame-by-frame quality is performed by raising the QP value of the next input video frame and, simultaneously, skipping the one or more second video frames that are allocated the one or more zero-delta frame macro-blocks.

14. The system of claim 12, wherein the normal level of complexity is required for the second current video frame to pass to and be displayed at the sink device without deteriorating an image associated with the second current video frame.

15. A method comprising:
receiving a video stream having a plurality of video frames, wherein the video stream is received frame-by-frame;
determining an input data rate relating to a first current video frame of the plurality of video frames received at the encoding mechanism; and
generating one or more zero-delta frames based on the input data rate, and allocate the one or more zero-delta frames to one or more first video frames of the plurality of video frames subsequent to the first current video frame.

16. The method of claim 15, further comprising calculating a quantization parameter (QP) value, and apply the calculated quantization parameter value to a next input video frame.

17. The method of claim 15, further comprising transmitting the video stream to a sink device coupled to the source device while managing frame-by-frame transmission of the video stream when the first current video frame consumes an amount of bandwidth that is determined to be greater than a normal amount of bandwidth required to communicate a single frame of the video stream.

18. The method of claim 17, wherein managing the frame-by-frame transmission is performed by raising the QP value of the next input video frame and, simultaneously, skipping the one or more first video frames that are allocated the one or more zero-delta frames.

19. The method of claim 18, further comprising generating one or more zero-delta frame macro-blocks based on the input data rate, and allocate the one or more zero-delta frame macro-blocks to one or more second video frames of the plurality of video frames subsequent to a second current frame, wherein the second current frame has a level of complexity that is determined to be greater than a normal level of complexity required to deliver and display the video stream at a normal quality.

20. The method of claim 18, further comprising transmitting the video stream to the sink device coupled to the source device while maintaining frame-by-frame quality of the video stream, wherein maintaining the frame-by-frame quality is performed by raising the QP value of the next input video frame and, simultaneously, skipping the one or more second video frames that are allocated the one or more zero-delta frame macro-blocks.
